(19) United States
(12) Patent Application Publication
(10) Pub. No.: US 2008/0255995 A1
(43) Pub. Date: Oct. 16, 2008

(54) POINT OF DELIVERY/SALE SIGNATURE CAPTURE SYSTEM AND PROCESS

(75) Inventor: Gregory Madden, Evansville, IN (US)

Correspondence Address: ICE MILLER LLP, ONE AMERICAN SQUARE, SUITE 3100, INDIANAPOLIS, IN, 46282-0200, US

(73) Assignee: MaddenCo Communications, Inc., (an Indiana corporation), Evansville, IN (US)

(21) Appl. No.: 12/104,245

(22) Filed: Apr. 16, 2008

Related U.S. Application Data
(60) Provisional application No. 60/912,017, filed on Apr. 16, 2007.

(51) Int. Cl. G06Q 20/00

(52) U.S. Cl. 705/76; 235/380; 705/21

(57) ABSTRACT

A device, system and method for the collection and management of point of delivery/sale information. A device is described that combines transaction data and a captured signature into the same file or data packet for storage in a database. Additionally, a system and method are described for using the device to record point of sale/delivery data, associate the recorded point of sale/delivery data with relevant transaction data, save the point of sale/delivery data and the transaction data into the same file, and store the image file in a database for later retrieval.

### RELATED APPLICATION

This U.S. Utility Application claims priority to U.S. Provisional Patent Application 60/912,017, which was filed Apr. 16, 2007. The contents of this application is hereby incorporated by reference in its entirety into this disclosure.

### BACKGROUND

Transaction and shipping information has historically been stored in the form of paper receipts. Over the years, various types of software and equipment have been developed that provide for the electronic acquisition, transmission, and storage of such information. The data capture processes of the prior art collect various sets of information and store such sets of information in separate files or data packets. For example, information manually entered into a keyboard is stored in one file or data packet and an electronic signature captured by a signature capture device is stored in another file or data packet. Therefore, several files and/or data packets often must be independently transferred when the collected information is transmitted to a central database for storage. Because the related files and/or data packets must be independently transferred, the possibility exists that the files may be disassociated from each other, saved incorrectly, lost, or even misused. Accordingly, with the data capture processes of the prior art, there is no guarantee that a person's electronic signature will be associated with the correct transaction information.

Companies in the tire industry specifically can relate to this problem because the nature of their industry requires delivery personnel to make large deliveries to multiple clients each day. It is imperative that the deliveries and corresponding records of delivery acceptance are accurate because if they are incorrect, customers may object to paying for such deliveries. Accordingly, the delivery person typically collects signed receipts from each customer evidencing the customer's acceptance of the shipment. After a day of deliveries, it is not uncommon for the delivery person to have acquired a large number of signed delivery receipts. Therefore, if the company utilizes a paper-based system, there are multiple signed paper receipts to be filed at the end of each day, assuming all of the signed receipts reach the office and are not lost along the way.

While the data capture processes of the prior art have helped to alleviate the amount of paper work required, they have not completely solved the problem with file management. This is because even if a tire company utilizes a data capture process of the prior art to collect electronic signatures, such signatures are independent of the delivery/sale documentation. Even employing such data capture processes of the prior art, it remains necessary to sort through the day's deliveries to match each of the electronic signatures with the corresponding delivery/sale information. As expected, it is not uncommon for the electronic signatures to be unidentifiable, disassociated from the related delivery information, or lost altogether because the captured signature and shipment information are stored in separate files. Therefore, it would be desirable for a data capture terminal to be able to combine transaction data and a captured signature into the same file or data packet, so that the single file or data packet containing all of the collected data from the point of delivery/sale can be stored in a database.

### BRIEF DESCRIPTION OF THE DRAWINGS

FIG. 1 shows a perspective view of an embodiment of a data capture device;

FIG. 2 shows a schematic view of an embodiment of the components housed within the data capture device of FIG. 1;

FIG. 3 shows a schematic view of an embodiment of further components housed within the data capture device of FIGS. 1 and 2;

FIG. 4a shows a side view of an optional embodiment of a data capture device;

FIG. 4b shows a perspective view of an optional embodiment of a data capture device;

FIG. 5 shows a flow chart of an embodiment of a method for collecting and storing transaction data and a signature;

FIG. 6 shows a block diagram of an embodiment of a system for collecting and storing transaction data and a signature; and

FIG. 7 shows a representation of one embodiment of an image file produced by the method and system shown in of FIGS. 5 and 6.

### SUMMARY

Devices, systems and methods are provided for the collection and management of point of sale/delivery information. In one embodiment, the device comprises a processor capable of executing a software program, a memory device coupled with the processor and capable of storing data, and at least one input device coupled with the processor and capable of receiving and transmitting data. Further, in this embodiment, the processor and the memory device are contained within a housing and the processor is capable of executing the software program to overlay a second set of data over a first set of data, which thereby combines the first set of data and the second set of data into a single file. The at least one input device may further comprise a keypad, a signature capture device, a scanner, a camera, a microphone, a global positioning system unit, a telephone, or any combination of the aforementioned. Such input devices may be located within the housing, external to the device, or certain components of a single input device may be located within the housing while other components of the input device may be positioned externally of the housing.

The device may further comprise a wireless device for transmitting and receiving data wirelessly. In these embodiments, the wireless device may be coupled with the processor and the processor may control the transmission of data to and from the wireless device. Non-limiting examples of such wireless devices may include an Ethernet card, a radio transmitter, and a Wi-Fi card.

In additional embodiments, a device further comprises a display screen that is electronically coupled with the processor and capable of providing a visual indication of the data. The display screen may comprise a liquid crystal display and may be used to display the first set of data and the second set of data thereon. Further, in at least one embodiment, the display screen further comprises a signature capture input device that is capable of receiving the second set of data or an electronic signature from a user. In addition, the device may comprise a plurality of indicators, such as light-emitting diodes, and at least one antenna capable of receiving and transmitting an electromagnetic signal, or any other signal known in the art.

In yet another embodiment, a device for collecting and compiling data into a single file is described. This device comprises a signature capture pad, a processor electronically coupled with the signature capture pad, and at least one input device electronically coupled with the processor. In this embodiment, the device is capable of obtaining at least one set of transaction data, obtaining at least one electronic signature through the signature capture pad, combining the at least one set of transaction data and the at least one electronic signature into a single file with the processor, and transferring the file to a database for storage. In one embodiment, the single file created by the processor comprises an image file. Further, in the embodiment where the device further comprises a display screen, the display screen is capable of providing a visual indication of the at least one set of transaction data and the at least one electronic signature for a user to review. In addition, one of the input devices of the device may comprise a keypad. In this manner, a user is able to view the transaction data on the display screen and use the keypad to supplement the transaction data with any supplemental data that may be necessary to either correct, update, or change the transaction data. In this embodiment, the processor is capable of receiving the supplemental data input through the keypad and combining the supplemental data and the at least one set of transaction data. Accordingly, the supplemented first set of data (i.e. the combination of the supplemental data and the at least one set of transaction data) is displayed on the display screen.

As previously mentioned, the device may further comprise a housing configured to enclose at least the processor therein. In one embodiment, a memory device and/or a database may also be enclosed within the housing. Further, at least one of the at least one input devices may be enclosed within the housing. The exterior of the housing may further comprise a mounting bracket affixed thereto. In at least one embodiment, a handle is configured to securely couple with the mounting bracket such that the handle provides a gripping surface for a user to easily grip the handle and support and operate the device. The handle may comprise a plurality of controllers capable of operating the at least one input device and the processor when the device is coupled with the handle. In an alternative embodiment, a clip may be provided to securely couple with the mounting bracket. In this embodiment, the clip may be used attach the device to a user's clothing, a stationary base, or other object.

In another embodiment, a method is provided for collecting and compiling data into a single file and includes transferring at least one set of data to the data capture device; capturing a signature with the data capture device; combining the signature and the at least one set of data into a single file; and transferring the file from the data capture device to a remote database. In certain embodiments of the method, the method may include the steps of transferring the first set of data to the data capture device; capturing the second set of data with the data capture device; combining the second set of data and the first set of data into a single file through execution of a software program of the data capture device; and transferring the file from the data capture device to a database. In one embodiment, when the second set of data is combined with the first set of data, the processor permanently overlays the second set of data over the first set of data and saves the first set of data and the second set of data as a single image file. Once the file is created by the processor, the data capture device can either save the file to the local memory device or database within the data capture device itself, or transmit the file to a remote database for storage. In one embodiment, all of the files are stored to the local memory or database of the data capture device and transferred to a remote database when the data capture device is connected to a computer, server, or other data management system. In addition, and as previously described herein, the device may further comprise a wireless device that is used to wirelessly transmit the file to a remote database.

When the device further comprises a display screen, the following additional steps may be added to the method: entering the first set of data into a system; displaying the first set of data on the display screen for a user to review; and prompting the user to input the second set of data into the device using at least one of the at least one input devices. In one embodiment, when the device comprises a signature capture device, the second set of data that the user enters is the user's signature.

When the method is used in conjunction with an embodiment of the signature capture device that comprises a signature capture pad for receiving a signature from a user and a digitizer for converting the signature into digital data that is processed by the processor, the method may further comprise a series of steps for allowing a user to alter the first set of data displayed on the display screen in the event an error is located or if the transaction has changed. Accordingly, the method may further comprise the steps of: prompting the user to update the first set of data; receiving supplemental data from the user through one of the at least one input devices, such supplemental data adding on to, amending, and/or deleting a portion or all of the first set of data; and displaying the supplemented first set of data on the display screen for the user's review.

In yet another embodiment, a system is provided for using the device disclosed herein to collect and store transaction data. One embodiment of the system comprises a database, a data management system for entering data into the database, and at least one embodiment of the data capture device previously disclosed. In at least one non-limiting example, the data management system may comprise a computer, a laptop, a server, or a microprocessor. More than one data capture devices may be used in conjunction with the systems disclosed herein. In one embodiment, the database of the system is remote and the data capture device comprises a wireless device for transferring the collected images to the remote database for storage.

### DESCRIPTION

Reference will now be made to the embodiments illustrated in the drawings and specific language will be used to describe the same. It will nevertheless be understood that no limitation of scope is intended by the description of these embodiments.

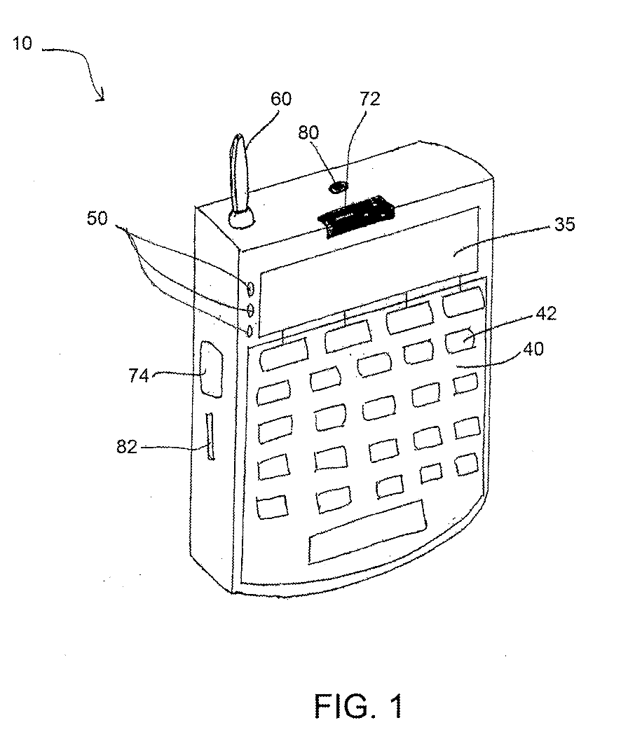

FIG. 1 shows an embodiment of a portable hand-held data capture device 10. The hand-held data capture device 10 may comprise an elongated housing formed in a manner so as to enable a user to hold the device 10 comfortably in one hand for an extended period of time. The device contains various components that allow the device to capture data.

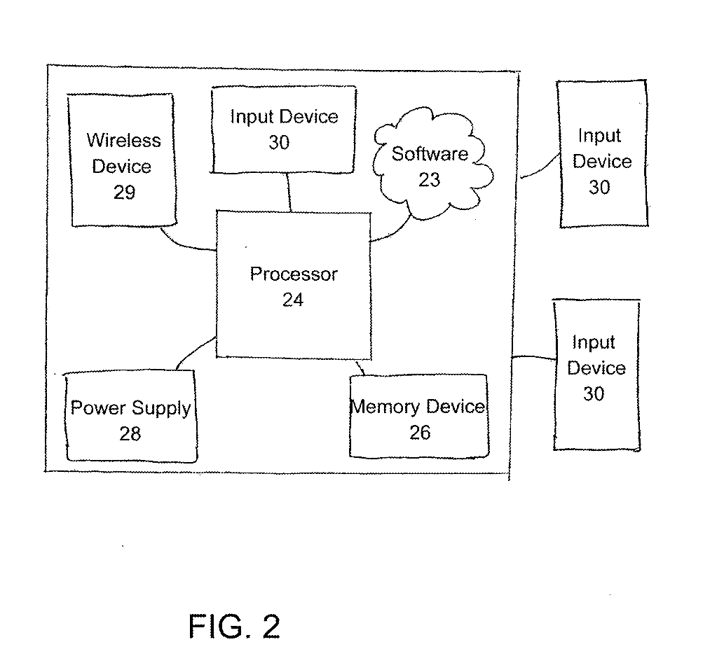

FIG. 2 shows a schematic view of an embodiment of components housed in the data capture device 10. As shown in FIG. 2, the data capture device 10 may house a processor 24, a memory device 26, and a power supply 28. The processor 24 is capable of enabling the data capture device 10 to function and execute a software program 23 to monitor and independently control each of the peripheral devices coupled with the data capture device 10. The memory device 26 may be electronically connected to the processor 24 and is capable of storing data received from the processor 24. The power supply 28 operates to power the data capture device 10 and may also be coupled with the processor 24. The power supply 28 may be comprised of a rechargeable battery pack, a plurality of batteries, or any other energy sources commonly known in the art. The processor 24 may be comprised of a computer chip, a microprocessor, or any other like device.

The data capture device 10 may further comprise a wireless device 29 capable of transmitting and receiving data wirelessly. In this embodiment, the wireless device 29 is enclosed within the housing of the data capture device 10. The wireless device 29 is further electronically connected to the processor 24 such that the processor 24 is capable of controlling the transmission of data to and from the wireless device 29 and manipulating the transfer of the received data from the wireless device 29 to the memory device 26 for storage. The wireless device 29 may comprise an Ethernet card, a radio transmitter, a Wi-Fi card, or any device commonly known in the art that is capable of transmitting and receiving information wirelessly.

Referring back to FIG. 1, the data capture device 10 may further comprise at least one display screen 35, a plurality of indicators 50, and at least one antenna 60. The at least one display screen 35 may be electronically connected to the processor 24 and may comprise any display that is capable of providing a visual indication to a user of various types of information. In one embodiment of the data capture device 10 of this disclosure, the display screen 35 may comprise a liquid crystal display (“LCD”).

The plurality of indicators 50 may comprise light-emitting diodes or any other suitable technology known in the art. The plurality of indicators 50 may be electronically connected to the processor 24 and may function to indicate the status of processes being performed by the processor 24, the occurrence of a specific event (for example, the wireless device 29 receiving a wireless Internet signal), or the acceptance of data by the processor 24. It will be recognized by one of skill in the art that while the plurality of indicators 50 are illustrated in FIG. 1 as being coupled with the front of the housing of the data capture device 10, the plurality of indicators 50 may be positioned on any location of the housing of the data capture device 10.

The at least one antenna 60 of the data capture device 10 may be any transducer known in the art that is capable of transmitting and receiving electromagnetic waves. While the at least one antenna 60 is illustrated in FIG. 1 as being coupled with the top portion of the housing and protruding therefrom, it is appreciated by one skilled in the art that the at least one antenna 60 may be completely enclosed within the housing and/or coupled with any component of the data capture device 10.

Referring to FIGS. 1 and 2, the data capture device 10 further comprises at least one input device 30. The at least one input device 30 may include any device coupled with the data capture device 10 that is capable of receiving data and transmitting that data to the processor 24. The data transmitted to the processor 24 from the input device 30 may be transmitted to the at least one display screen 35. In this manner, a user can immediately view the data captured by the at least one input device 30 on the at least one display screen 35. In one embodiment the input devices 30 are a keypad 40 with keys 42, a scanner 72 that can be used to scan barcodes or images, and a camera with an imaging device or lens 80. Other input devices 30 that may be included with the data capture device 10 include, but are not limited to, a microphone, a global positioning system unit (“GPS”), a telephone, or any device commonly known in the art that is capable of receiving and transmitting data to the processor 24.

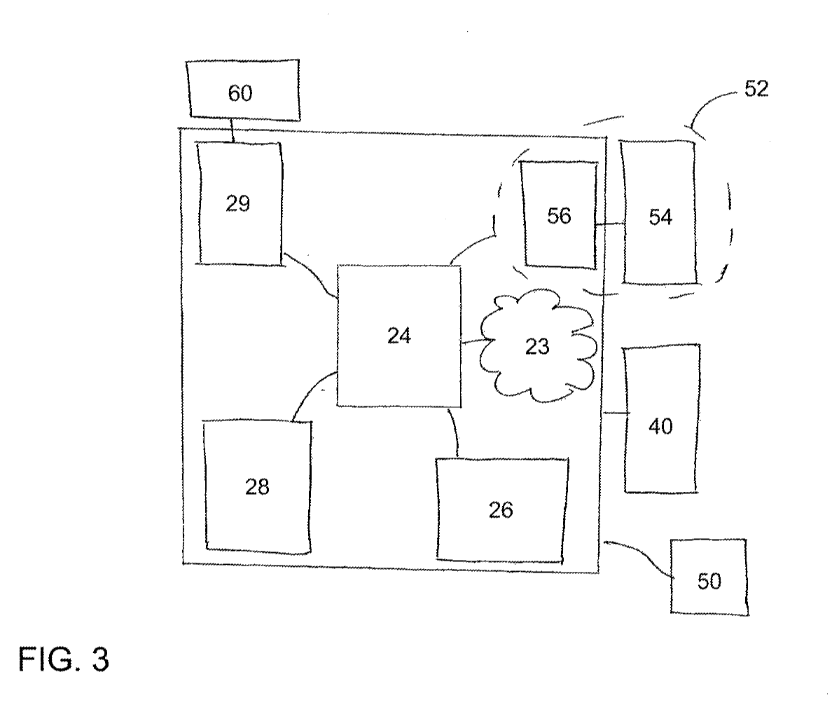

FIG. 3 shows a schematic view of at least one embodiment of a data capture device 10 having an input device 30 that comprises a signature capture device 52. In this embodiment, signature capture device 52 has a signature capture pad 54 and a digitizer 56. The digitizer 56 is capable of providing a digital signature corresponding to a signature obtained on the signature capture pad 54. In this embodiment, the digitizer 56 is enclosed within the housing of the data capture device 10 and electronically coupled with the signature capture pad 54 and the processor 24 such that the processor 24 may obtain the digitized signature from the digitizer 56 and transfer the digitized signature to the memory device 26 for storage.

One of ordinary skill in the art would appreciate that the signature capture device 52 may comprise any input device known in the art that is capable of capturing a signature from a user and transferring the captured signature to the processor 24. In one embodiment, the signature capture pad 54 is a component of the at least one display screen 35 (shown in FIG. 1). In this embodiment, the display screen 35 functions to receive data as well as display data captured by the other input devices 30.

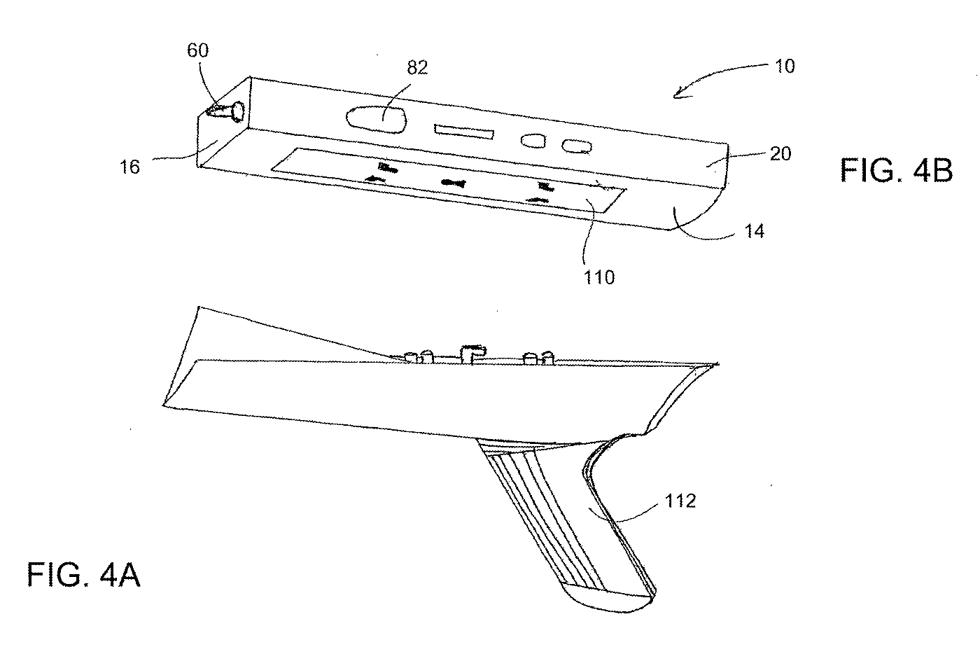

While FIGS. 1-3 describe embodiments of the data capture device 10, it will be appreciated by one skilled in the art that any number of like devices may be used. For example, in the at least one embodiment shown in FIGS. 4a and 4b, the data capture device 10 further comprises a mounting bracket 110 for a handle 112 or a clip (not shown). The mounting bracket 110 may be coupled to the back portion 14 of the data capture device 10 and may be comprised of any suitable material. Further, the mounting bracket 110 may be configured in any manner such that the mounting bracket 110 is capable of removably securing the data capture device 10 to the handle 112 or the clip.

While the handle 112 is illustrated as a pistol grip handle in FIG. 4a, the handle 112 may comprise any configuration. In at least one embodiment, the handle 112 is designed to facilitate the ease of use of the data capture device 10 such that the data capture device 10 may be maneuvered easily by a user. The handle 112 may further comprise controllers (not shown) such that specific functions of the data capture device 10 may be controlled through the handle 112 when the data capture device 10 is removably mounted thereon. As mentioned above, in an alternative embodiment, the mounting bracket 110 may be configured to couple with a clip (not shown). In this embodiment, the clip (not shown) may comprise any configuration so long as the clip facilitates the attachment of the data capture device 10 to an item of clothing or other accessory, such as a bag. It will be appreciated by one of ordinary skill in the art that any type of data capture device can be used.

In application, the data capture device 10 can generally be used to capture data through the input devices 30, process the captured data, and either store the captured data in the memory device 26 or transfer the data to a remote database. Furthermore, the data capture device 10 allows a user to communicate with a remote computer in “real time” by operation of the keypad 40 or any of the at least one input devices 30 of the data capture device 10. In this manner, the data capture device 10 can be used to immediately communicate information gathered in the field to a person in a remote location.

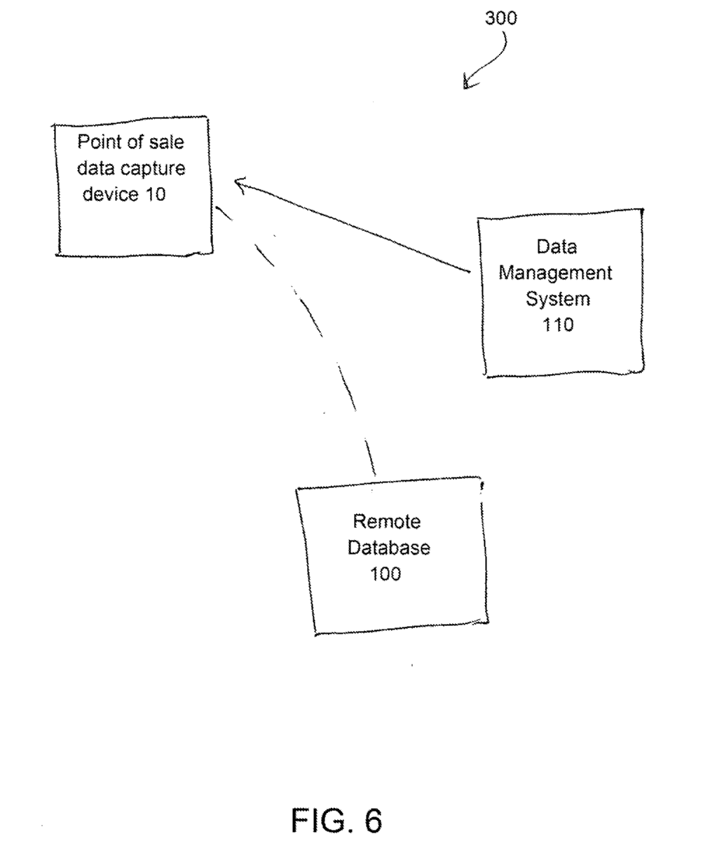

Referring to FIG. 6, one embodiment of a signature capture system 300 is shown. In this embodiment, signature capture system 300 is utilized to collect data, display data to a customer on a display screen (e.g., customer name, date and time, document/invoice number, dollar amount, or any other information desired to be associated with a particular transaction), and capture a signature from a customer on top of the displayed data, thereby permanently combining the collected data and the signature into a single file (i.e., an image file). For example, the signature capture system 300 may be used at a point of sale terminal to collect purchase data, capture a customer's signature over the embedded relevant information, and produce a signed electronic receipt.

In the embodiment shown in FIG. 6, system 300 includes at least one data capture device 10, a data management system 110, and a remote database 100. The data capture device 10 is capable of communicating with the data management system 110 and the remote database 100 through any means commonly known in the art, including, but not limited to, network or wireless communications and wires or cables. Any number of data capture devices 10 may be used in conjunction with the system 300. For example and without limitation, a fleet of delivery truck drivers may each be issued a data capture device 10, each of the data capture devices 10 being in communication with the data management system 110 and connected to the same remote database 100.

The data management system 110 may be comprised of any computer system, such as desk top computer, a laptop, a processor, a server, a microprocessor, or any other means known in the art, so long as the system is capable of receiving, compiling and electronically transferring transaction information. It will also be appreciated that the data management system 110 and the database 100 can be the same system instead of separate components.

System 300 allows a user to maintain a comprehensive record of transaction details without concern for separate files being lost or misrouted. The user is able to store the complete record in an easily accessible database, which allows the record to be conveniently accessed at any time if a dispute surrounding a transaction arises. For example, in the event of a disputed product delivery that allegedly occurred in the past, a user of the data capture system 300 can immediately access a single file containing the detailed delivery/sale information embedded with the corresponding electronic signature—the signature evidencing that the delivery was accepted. Furthermore, the data capture system 300 also allows for copies of the stored files to be sent to a customer inquiring about a specific sale/delivery. For example, an electronic copy of an invoice having the electronic signature and corresponding detailed delivery/sale information embedded therein can be emailed to a client or the client can independently access his or her invoices on the remote database 100 using the Internet, or a similar connection, and his or her personal computer.

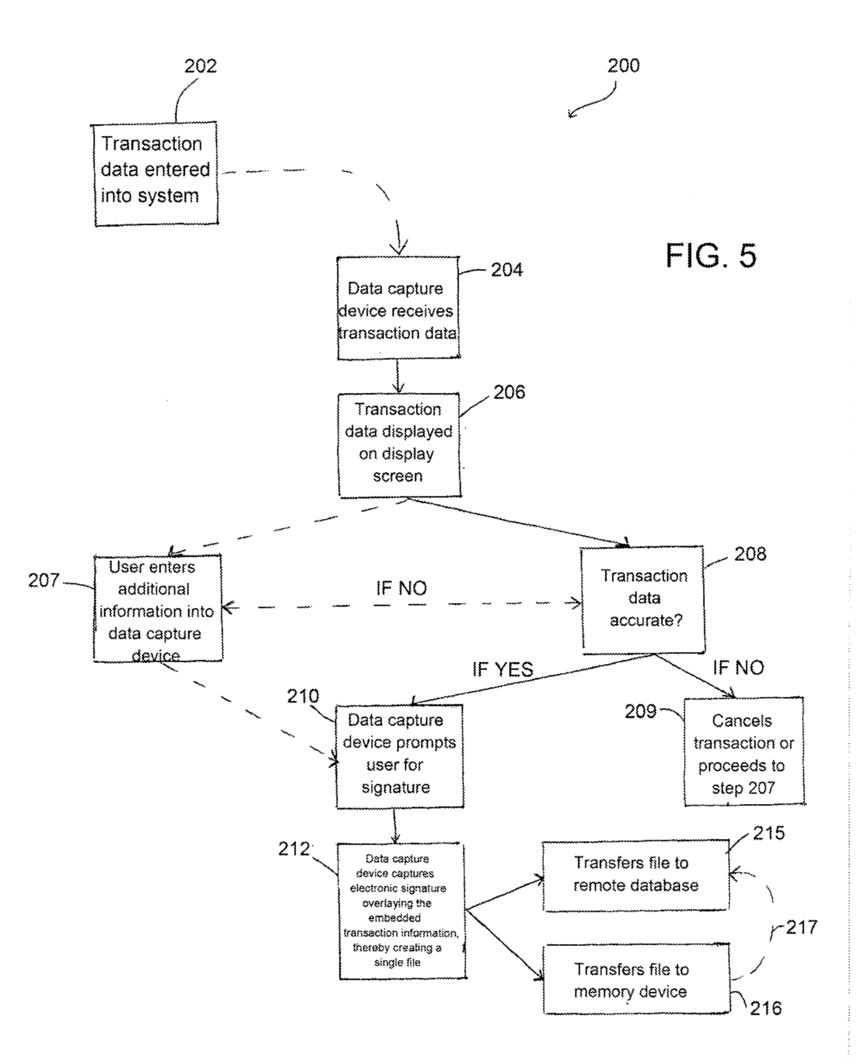

FIG. 5 shows a flow chart of an embodiment of a signature capture method 200 for collecting a signature on top of the embedded relevant transaction information at the point of delivery/sale. For ease of understanding, the steps of FIG. 5 will be discussed relative to the data capture device 10 shown in FIGS. 1-3, but it will be appreciated by one skilled in the art that any such device can be used to perform this method so long as it has a processor and the necessary input devices that can be programmed to execute the necessary steps.

As shown in FIG. 5, a user can utilize the data management system 110 shown in FIG. 6 to enter in all of the relevant transaction data for an order (i.e. site of the delivery, the price, date of delivery, etc.) in step 202. This transaction data can then be transferred electronically to the data capture device 10 and stored in the memory device 26. For example, the transaction data can be wirelessly transferred from the data management system 110 to the data capture device 10 through a wireless connection, and stored in the memory device 26. After the transfer, a user of the data capture device 10 can then view several different orders that correspond to the user's deliveries through the display screen 35. At the time of delivery, the user can, in step 206, select the relevant order to access from the memory device 26 and display the corresponding stored transaction data on the display screen 35. In step 207, the user has the option to enter any notes or further information into the data capture device 10 that the user desires to be associated with the transaction. Thus, in optional step 207, such further information is entered and embedded with the previously entered transaction data and displayed on the display screen 35 therewith. If the user does not enter additional information at step 207, the method 200 allows the user to proceed directly from displaying the information at step 206 to step 208.

In step 208, the user can show the information to the purchaser and the purchaser can confirm if the information is accurate. If the information is incorrect, the order can be refused or cancelled in step 209. Alternatively, the user may go back to step 207 and enter further information, such as a note explaining any discrepancy in a delivery. Once this further information is added at step 207, the method 200 again proceeds to step 208 such that the purchaser can view the totality of the information and confirm if it is accurate. Assuming the information is correct and/or acceptable to the purchaser, the purchaser can accept the order by signing this transaction information on the display screen 35 in steps 210-212.

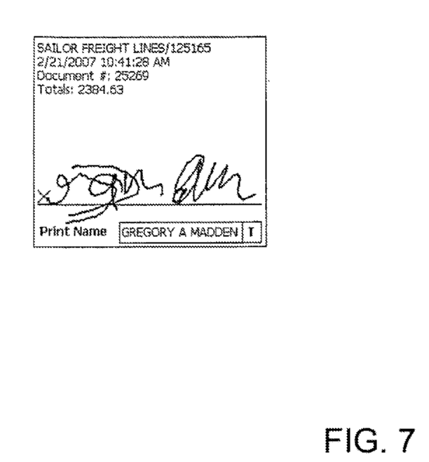

The purchaser's signature is captured ‘overlaying’ the relevant embedded information with the data capture device 10, and the signature and transaction information are then saved as a single image file at step 212. The image file ensures that the signature and transaction information cannot be edited or separated at a later point in time. In this manner, the method keeps a record of any transactions at the point of delivery/sale. FIG. 7 shows one embodiment of an image file containing the electronic signature with the collected data embedded therein. The data capture device 10 then transfers the image file to the memory device 26 for temporary storage at step 216, or immediately transfers the image file to the remote database 100 for storage at step 215. If the user transfers the single image file to the memory device 26, the single image file can be temporarily stored therein for a period of time until the user desires to transfer the single image file to the remote database 100 in step 217.

The transfer of the image file to the database 100 may occur wirelessly through the wireless device 29 or by linking the data capture device 10 directly to the database 100 (e.g., through data transferring wires, a docking system, or other like devices). For example, if a docking system is used, the docking system may include a cradle having a plurality of input/output components that are capable of coupling with corresponding ports located on the data capture device 10. In this embodiment, the docking system may receive the file from the data capture device 10 through the input/output components and thereafter transfer the file to the remote database in any manner commonly known in the art. It will be appreciated by those skilled in the art that the docking system can be any docking device known in the art that is capable of receiving the file from the data capture device 10 and thereafter transferring the file to a remote database.

It will be appreciated that a user of data capture device 10 may also input data into the data capture system 300 through the keypad 40 (such as a note about a missing or damaged part). Furthermore, a user may utilize a scanner device 72 to scan a barcode to capture transaction data or the processor 24 may prompt the wireless device 29 to withdraw data from the remote database 100 over a wireless connection to populate pre-delivered fields. In addition, a GPS could be used to automatically record the physical location of the transaction. These are optional steps that can be added to the illustrative method 200 in FIG. 5.

By performing this method 200, a user may use the data capture device 10 to immediately transfer the single file containing all of the captured information to a remote database for storage. If any issue arises, this image file can be accessed to show the relevant information and that the purchaser signed off on the transaction. In this manner, it will be indisputable as to the specific details of the transaction. For example, for users executing the method 200 with the data capture device 10, it could also be possible to record the exact time, date, and location of the transaction (utilizing a GPS unit), the exact goods conveyed in the transaction (utilizing either the scanner 72, the keypad 40, or the camera device), and the name and/or identifying characteristics of who signed for the transaction (utilizing the signature capture device 52, the keypad 40, and/or the camera device). It will also be appreciated that a device performing such a method allows the user to maintain a complete record of the transaction details without concern for separate files being lost, misrouted, or misused.

In the embodiments discussed herein, such a system and method eliminates the potential for mismanaging electronic records and failing to collect sufficient information about a transaction. While various embodiments of devices, systems, and methods for capturing and saving data have been described in considerable detail herein, the embodiments are merely offered by way of non-limiting examples. Accordingly, it is understood that no limitation of scope is intended by the description of these embodiments.

Further, many variations and modifications of the embodiments described herein will be apparent to one of ordinary skill in the art in light of the disclosure. For example, method 200 is not just limited to just delivery of merchandise but may be used for a number of different sales-related transactions. The method 200 may be used with a data capture device 10 connected to a cash register in order to incorporate a signature (i.e., for a credit card) with the desired transaction data. It will therefore be understood by those skilled in the art that various changes and modifications may be made, and equivalents may be substituted for elements thereof, without departing from the scope of the disclosure. Indeed, this disclosure is not intended to be exhaustive or limiting. The scope of the disclosure is to be defined by the appended claims, and by their equivalents.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps disclosed herein should not be construed as limitations on the claims. In addition, the claims directed to a method and/or process should not be limited to the performance of their steps in the order written, and one skilled in the art can readily appreciate that the sequences may be varied and still remain within the spirit and scope of the present disclosure.

It is therefore intended that this description and the appended claims will encompass, all modifications and changes apparent to those of ordinary skill in the art based on this disclosure.

1. A device for collecting and compiling data into a single file, the device comprising:
a signature capture pad;
a processor electronically coupled with the signature capture pad; and
at least one input device electronically coupled with the processor;
wherein the device is capable of obtaining at least one set of transaction data, obtaining at least one electronic signature through the signature capture pad, combining the at least one set of transaction data and the at least one electronic signature into a single file with the processor, and transferring the file to a database for storage.

2. The device of claim 1, wherein the file comprises an image file.

3. The device of claim 1, further comprising a display screen electronically coupled with the processor and capable of providing a visual indication of the at least one set of transaction data and the at least one electronic signature.

4. The device of claim 3, wherein one of the at least one input devices comprises a keypad capable of receiving supplemental data, and wherein the processor is capable of combining the supplemental data with the at least one set of transaction data.

5. A method for collecting and compiling data into a single file, the method comprising the steps of:
providing a data capture device, the device comprising:
a processor capable of executing a set of instructions,
a memory device coupled with the processor and capable of storing data received from the processor, and
at least one input device coupled with the processor and capable of receiving and transmitting the data,
wherein the processor and the memory device are contained within a housing and the processor is capable of overlaying an electronic signature over the transaction data;
transferring the transaction data to the data capture device;
capturing the electronic signature with the data capture device;
combining the electronic signature and the transaction data into a single file through execution of the set of instructions; and
transferring the file from the data capture device to a database.

6. The device of claim 5, wherein the at least one input device is selected from a group consisting of a keypad, a signature capture device, a scanner, a camera, a microphone, a global positioning system unit, and a telephone.

7. The method of claim 6, wherein the data capture device further comprises a display screen electronically coupled with the processor for providing a visual indication of the transaction data and the electronic signature and further comprising the steps of:
entering the transaction data into a system;
displaying the transaction data on the display screen; and
prompting a user to input the electronic signature through at least one of the at least one input devices.

8. The method of claim 7, wherein one of the at least one input devices comprises a signature capture device having a signature capture pad and a digitizer, the signature capture pad for receiving a signature from a user and the digitizer for converting the signature into the electronic signature.

9. The method of claim 8, further comprising the steps of:
prompting the user to update the transaction data;
receiving supplemental data through at least one of the at least one input devices; and
displaying the supplemental data and the transaction data on the display screen.

10. The method of claim 9, wherein the step of capturing the electronic signature with the data capture device further comprises the steps of:
receiving a signature through operation of the signature capture pad;
converting the signature into an electronic signature through operation of the digitizer; and
transmitting the electronic signature to the processor.

11. The method of claim 5, wherein the step of combining the electronic signature and the transaction data into a single file through execution of the set of instructions further comprises permanently overlaying the electronic signature over the transaction data and saving the transaction data and the electronic signature as a single image file.

12. The method of claim 5, further comprising the step of transferring the file to the memory device for temporary storage.

13. The method of claim 5, wherein the data capture device further comprises a wireless device electronically coupled with the processor and capable of transmitting and receiving data wirelessly, and wherein the step of transferring the file from the data capture device to a remote database further comprises wirelessly transferring the file from the data capture device to the remote database through operation of the wireless device.

14. The method of claim 5, wherein the step of transferring the file from the data capture device to a remote database further comprises linking the data capture device directly to the remote database through a docking system.

15. The method of claim 9, further comprising the step of prompting a user to confirm the accuracy of the transaction data.

16. The method of claim 5, wherein the data capture device further comprises a point of sale terminal.

17. A system for collecting and storing transaction data, the system comprising:
a database;
a data management system for entering data into the database; and
at least one data capture device having a signature capture pad, a processor and at least one input device, wherein the at least one device obtains at least one set of transaction data from the data management system, obtains at least one electronic signature through the signature capture pad, combines the at least one set of transaction data and the at least one electronic signature into a single image file with the processor, and transfers the image file to the database for storage.

18. The system of claim 17, wherein the database comprises a remote database and the data capture device further comprises a wireless device for transferring the image file to the remote database for storage.

19. The system of claim 17, wherein the data management system is selected from a group consisting of a computer, a server, and a microprocessor.

20. The system of claim 17, wherein the system comprises a plurality of data capture devices.
